(19) United States
(12) Patent Application Publication
(10) Pub. No.: US 2026/0008494 A1
(43) Pub. Date: Jan. 8, 2026

(54) STEERING CONTROL SYSTEM, STEERING CONTROL APPARATUS AND METHOD

(71) Applicant: HL MANDO CORPORATION, Gyeonggi-do (KR)

(72) Inventors: Taesik KIM, Gyeonggi-do (KR); Kyuyeong JE, Gyeonggi-do (KR)

(21) Appl. No.: 19/262,873

(22) Filed: Jul. 8, 2025

(30) Foreign Application Priority Data
Jul. 8, 2024 (KR) 10-2024-0089895
Jun. 23, 2025 (KR) 10-2025-0083045

(51) Int. Cl. B62D 5/04; B62D 6/00

(52) U.S. Cl. CPC B62D 5/0484; B62D 5/0493; B62D 6/008

(57) ABSTRACT

The present embodiments relate to an apparatus and method for controlling steering of a vehicle, and may provide an apparatus and method for receiving at least one of a steering angle of a steering wheel connected to a Steering Feedback Actuator (SFA), a torque, first position information of a first rack connected to a Road Wheel Actuator (RWA), or status information of an ECU connected to each of the SFA and the RWA, determining whether the SFA or the RWA is in a failure state based on at least one of the steering angle, the torque, or the first position information, and controlling a switch element of the ECU based on the status information of the ECU connected to the SFA or the RWA in the failure state if the SFA or the RWA is determined to be in the failure state.

### CROSS-REFERENCE TO RELATED APPLICATIONS

This application claims the priority of Korean Patent Application Nos. 10-2024-0089895 filed on Jul. 8, 2024 and 10-2025-0083045 filed on Jun. 23, 2025, in the Korean Intellectual Property Office, the disclosure of which is incorporated herein by reference.

### BACKGROUND

### Field

The present embodiments relate to a technology for controlling a switch element included in an electronic control unit (ECU).

### Description of the Related Art

Development of an apparatus that drives a motor in an electronic control unit (ECU) to perform various steering and braking operations depending on operating conditions of a vehicle is actively underway.

For example, among the steering apparatuses, there is an electric power steering apparatus such as Electro-hydraulic Power Steering (EHPS), Motor Driven Power Steering (MDPS), or Electric Power Steering (EPS). In particular, the electric power steering apparatus can provide a lighter and more comfortable steering feel because power is assisted through the rotational force of the motor, unlike the hydraulic method that assists power by forming hydraulic pressure from a pump if the driver performs a parking maneuver.

In particular, steer by wire (SbW) is a system in which a steering wheel movement of a driver is converted into an electric signal to control the wheels of a vehicle, and each system included in the steer by wire is configured with a redundant structure that includes two systems. This allows the system to operate with 50% to 100% power depending on the design of the system, as only one system is activated if the other system is in a failure state.

However, in the case where both systems are in a failure state, a control method for moving the vehicle to a safe location is problematic.

### SUMMARY

The present embodiments may provide a technology for controlling a switch element included in an ECU.

In one aspect, the present embodiments relate to an apparatus for controlling steering of a vehicle by controlling a switch element included in an ECU, and may provide a steering control apparatus including: an information receiver that receives at least one of a steering angle of a steering wheel connected to a Steering Feedback Actuator (SFA), a torque, first position information of a first rack connected to a Road Wheel Actuator (RWA), or status information of an ECU connected to each of the SFA and the RWA; a failure determinator that determines whether the SFA or the RWA is in a failure state based on at least one of the steering angle, the torque, or the first position information; and a controller that controls a switch element of the ECU based on the status information of the ECU connected to the SFA or the RWA in the failure state if the SFA or the RWA is determined to be in the failure state.

In another aspect, the present embodiments relate to a method for controlling the steering of a vehicle by controlling a switch element included in an ECU, and may provide a steering control method including: receiving at least one of a steering angle of a steering wheel connected to a Steering Feedback Actuator (SFA), a torque, first position information of a first rack connected to a Road Wheel Actuator (RWA), or status information of an ECU connected to each of the SFA and the RWA; determining whether the SFA or the RWA is in a failure state based on at least one of the steering angle, the torque, or the first position information; and controlling a switch element of the ECU based on the status information of the ECU connected to the SFA or the RWA in the failure state if the SFA or the RWA is determined to be in the failure state.

In still another aspect, the present embodiments relate to an apparatus for controlling the steering of a vehicle by controlling a switch element included in an ECU, and may provide a steering control apparatus including: at least one memory including computer program instructions; and at least one processor executing the computer program instructions, in which the at least one processor receives at least one of a steering angle of a steering wheel connected to a Steering Feedback Actuator (SFA), a torque, first position information of a first rack connected to a Road Wheel Actuator (RWA), or status information of an ECU connected to each of the SFA and the RWA, determines whether the SFA or the RWA is in a failure state based on at least one of the steering angle, the torque, or the first position information, and controls a switch element of the ECU based on the status information of the ECU connected to the SFA or the RWA in the failure state if the SFA or the RWA is determined to be in the failure state.

The present embodiments can provide a technology for controlling the switch element included in the ECU.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram for explaining the configuration of a steering control apparatus according to one embodiment;

FIG. 2 is a configuration diagram schematically illustrating a steer-by-wire steering apparatus, which is one of the apparatuses to which the present embodiments can be applied;

FIG. 3 is another configuration view illustrating the steer-by-wire steering apparatus, which is one of the apparatuses to which the present embodiments can be applied;

FIG. 4 is a diagram for explaining a Single Point Failure and Dual Point Failure according to one embodiment;

FIGS. 5 and 6 are diagrams for explaining current flow in case of a three-phase short circuit according to one embodiment;

FIG. 7 is a diagram for explaining a method for controlling an ECU in case of Dual Lane PPk according to one embodiment;

FIG. 8 is a diagram for explaining a method for controlling an ECU in case of Dual Powerpack type according to one embodiment;

FIG. 9 is a flowchart for explaining a steering control process according to one embodiment; and

FIG. 10 is a block diagram of an exemplary computing system.

### DETAILED DESCRIPTION OF THE EMBODIMENT

In the following description of examples or embodiments of the present disclosure, reference will be made to the accompanying drawings in which it is illustrated by way of illustration specific examples or embodiments that can be implemented, and in which the same reference numerals and signs can be used to designate the same or like components even if they are illustrated in different accompanying drawings from one another. Further, in the following description of examples or embodiments of the present disclosure, detailed descriptions of well-known functions and components incorporated herein will be omitted if it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements or the like, but is used merely to distinguish the corresponding element from other elements.

If it is mentioned that a first element “is connected or coupled to”, “contacts or overlaps” or the like a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, or the like each other via a fourth element. Here, the second element may be included in at least one of two or more elements that “are connected or coupled to”, “contact or overlap”, or the like each other.

If time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, if any dimensions, relative sizes or the like are mentioned, it should be considered that numerical values for an elements or features, or corresponding information (for example, level, range, or the like) include a tolerance or error range that may be caused by various factors (for example, process factors, internal or external impact, noise, or the like) even if a relevant description is not specified. Further, the term “may” fully encompass all the meanings of the term “can”.

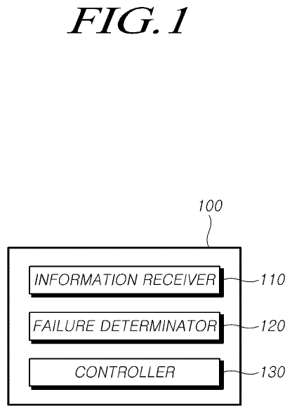

FIG. 1 is a diagram for explaining the configuration of a steering control apparatus according to one embodiment.

Referring to FIG. 1, the steering control apparatus 100 of the present disclosure includes an information receiver 110 that receives at least one of a steering angle of a steering wheel connected to a Steering Feedback Actuator (SFA), a torque, first position information of a first rack connected to a Road Wheel Actuator (RWA), or status information of an ECU connected to each of the SFA and the RWA.

The steering control apparatus 100 of the present disclosure may determine whether the SFA or RWA is in the failure state based on the received information. In addition, the steering control apparatus 100 of the present disclosure may receive second position information of a second rack from a Rear Wheel Steering (RWS) as needed.

The present disclosure proposes a method for enabling a motor to operate by controlling a switch element of an ECU connected to the SFA or RWA in the failure state if the SFA or RWA is in the failure state. In particular, the present disclosure proposes a method for preventing a first rack of the RWA from becoming free-rolling by controlling the switch element of the ECU mentioned above to provide a braking torque to the motor if the RWA is in the failure state, and controlling the steering of the vehicle through the second rack of the RWS.

The steering control apparatus 100 of the present disclosure includes a failure determinator 120 that determines whether the SFA or RWA is in the failure state based on at least one of the steering angle, the torque, or the first position information.

For example, the steering control apparatus 100 of the present disclosure may determine whether the SFA is in the failure state based on the steering angle and torque, and may determine whether the RWA is in the failure state based on the steering angle, torque, and first position information.

As another example, the status information of the aforementioned ECU may include any one of a normal state, a short circuit, and an open circuit, and at least one of the SFA or RWA may be connected to at least two ECUs.

As still another example, the at least two ECUs connected to the SFA may include a first High Side Inverter, a first Low Side Inverter, a second High Side Inverter and a second Low Side Inverter, and the at least two ECUs connected to the RWA may include a third High Side Inverter, a third Low Side Inverter, a fourth High Side Inverter, and a fourth Low Side Inverter.

The steering control apparatus 100 of the present disclosure may determine whether the SFA or RWA is in the failure state based on the status of each ECU described above, and control the steering of the vehicle by controlling the switch element included in the ECU connected to the apparatus in the failure state based on the determination result.

The steering control apparatus 100 of the present disclosure includes a controller 130 that controls the switch element of the ECU based on the status information of the ECU connected to the SFA or RWA in the failure state if the SFA or RWA is determined to be in the failure state.

In a case where the SFA or RWA is determined to be in the failure state, the steering control apparatus 100 of the present disclosure may control the switch element of each High Side Inverter to be ON if both High Side Inverters connected to the SFA or RWA are in the normal state. Alternatively, the steering control apparatus 100 may control the switch element of each Low Side Inverter to be ON if both Low Side Inverters connected to the SFA or RWA are in the normal state.

In addition, the steering control apparatus 100 of the present disclosure may control the switch elements of the ECU so that the motor is operated according to the status of the inverter of each ECU connected to the SFA or RWA.

For example, in a case where the SFA is determined to be in the failure state, the steering control apparatus 100 of the present disclosure may control the switch element of the first High Side Inverter and the switch element of the second High Side Inverter to be ON if the first High Side Inverter and the second High Side Inverter are in the normal states, and control the switch element of the first Low Side Inverter and the switch element of the second Low Side Inverter to be ON if the first Low Side Inverter and the second Low Side Inverter are in the normal states.

As another example, in a case where the SFA is determined to be in the failure state, the steering control apparatus 100 of the present disclosure may control the switch element of the first High Side Inverter to be ON if the first High Side Inverter is in the short circuit, and control the switch element of the first Low Side Inverter to be ON if the first Low Side Inverter is in the short circuit.

As still another example, in a case where the SFA is determined to be in the failure state, the steering control apparatus 100 of the present disclosure may control the switch elements of the first Low Side Inverter and/or the second High Side Inverter to be ON if the first High Side Inverter is in the open circuit, and control the switch elements of the first High Side Inverter and/or the second Low Side Inverter to be ON if the first Low Side Inverter is in the open circuit.

As still another example, in a case where the RWA is determined to be in the failure state, the steering control apparatus 100 of the present disclosure may control the switch element of the third High Side Inverter and the switch element of the fourth High Side Inverter to be ON if the third High Side Inverter and the fourth High Side Inverter are in the normal states, and control the switch element of the third Low Side Inverter and the switch element of the fourth Low Side Inverter to be ON if the third Low Side Inverter and the fourth Low Side Inverter are in the normal states.

As still another example, in a case where the RWA is determined to be in the failure state, the steering control apparatus 100 of the present disclosure may control the switch element of the third High Side Inverter to be ON if the third High Side Inverter is in the short circuit, and control the switch element of the third Low Side Inverter to be ON if the third Low Side Inverter is in the short circuit.

As still another example, in a case where the RWA is determined to be in the failure state, the steering control apparatus 100 of the present disclosure may control the switch elements of the third Low Side Inverter and/or the fourth High Side Inverter to be ON if the third High Side Inverter is in the open circuit, and control the switch elements of the third High Side Inverter and/or the fourth Low Side Inverter to be ON if the third Low Side Inverter is in the open circuit.

As still another example, the steering control apparatus 100 of the present disclosure may receive second position information of the second rack from the Rear Wheel Steering (RWS), and may control the switch element of the ECU connected to the RWA to provide braking torque to the first rack and control steering of the vehicle with the second rack based on the second position information if the RWA is determined to be in the failure state.

The present disclosure enables steering control of a vehicle by controlling the switch element of the motor mounted on the ECU if the SFA or RWA is in the failure state, and in particular, has an advantage in that the vehicle can be moved to a safe location even in a fault situation by controlling the steering of the vehicle through the RWS or other brake by preventing the rack of the RWA from becoming free-rolling if the RWA is in the failure state.

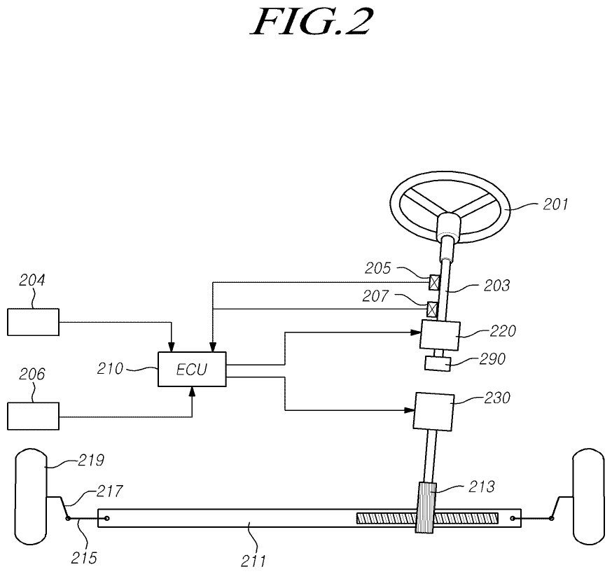

The above-described method is described in detail starting with FIG. 2.

FIG. 2 is a configuration diagram schematically illustrating a steer-by-wire steering apparatus, which is one of the apparatuses to which the present embodiments can be applied.

Referring to FIG. 2, in the steer-by-wire steering apparatus according to the present embodiments, an angle sensor 205 and a torque sensor 207 are coupled to one side of a steering shaft 203 connected to a steering wheel 201, and if a driver operates the steering wheel 201, the angle sensor 205 and the torque sensor 207 detect the operation of the steering wheel and send an electric signal to an electronic control device 210 to control a steering shaft motor 220 and a Powerpack shaft motor 230.

The steering shaft motor 220 is connected to a reducer 245 that reduces the rotational speed of the motor, and during normal traveling, a reaction force is provided to the steering shaft 203 so that the driver may feel a steering reaction force in the opposite direction in a case where the driver operates the steering wheel 201, and during autonomous traveling, steering is performed by the control of the electronic control device 210 without the intervention of the driver's will.

The Powerpack shaft motor 230 slides a rack bar 211 connected to a Powerpack shaft 213 to steer both wheels 219 through a tie rod 215 and a knuckle arm 217.

However, for convenience of explanation, the drawings in the present embodiments illustrate an example in which the angle sensor 205 and the torque sensor 207 provided on the steering shaft 203, a vehicle speed sensor 204 for transmitting steering information to the electronic control device 210, and a Powerpack shaft rotation angle sensor 206 are provided, but in addition, a motor position sensor, various types of radar and lidar, and image sensors such as cameras may be provided, and a detailed description thereof will be omitted below.

In this steer-by-wire steering apparatus, since the steering wheel 201 and the wheel 219 are not mechanically connected, the steering shaft motor 220 provides a reaction force to the driver. In addition, the Powerpack shaft motor 230 provides the steering force to the rack bar 211. The Powerpack shaft motor 230 and the rack bar 211 may be coupled in various ways, and there is no limitation thereto.

In the present disclosure, a motor that provides steering reaction force to the steering wheel in the steer-by-wire steering apparatus is referred to as a steering reaction motor. In addition, in the present disclosure, the above-described Powerpack shaft motor is the actuator that transmits a driver's steering intention to the vehicle wheels to move the wheels, and is referred to as a steering motor.

For example, the steer-by-wire steering apparatus may be configured to have either a Dual Lane Ppk structure having two independent channels for one motor each connected to the SFA or RWA, or a Dual Powerpack Type structure having one independent channel for one motor.

For example, a Dual Powerpack Type structure may include a structure in which two motors are connected to both sides of a single rack connected to the RWA to transmit steering force from both sides.

The SFA or RWA included in the steer-by-wire steering apparatus is configured with a redundant structure that includes two ECUs, so that if one ECU is in a failure state, the other ECU may be operated, enabling steering control with 50% of the power.

In addition, in the event of a Dual Point Failure in the SFA or RWA included in the steer-by-wire steering apparatus, there is a problem with the method for moving the vehicle to a safe location through steering control.

For example, in the event of the Dual Point Failure in the RWA having the Dual Lane PPk structure, steering control based on the RWS or other brakes may be attempted to move the vehicle to a safe location. However, if the rack of the RWA is in a free rolling state or the rack of the RWA is moved in an unintended direction due to an external impact, the steering control based on the aforementioned RWS or other brakes may be difficult.

Accordingly, the present disclosure proposes a method for controlling a switch element of an ECU connected to the faulty SFA or RWA so as to enable stable steering control of a vehicle if the SFA or RWA is in the failure state.

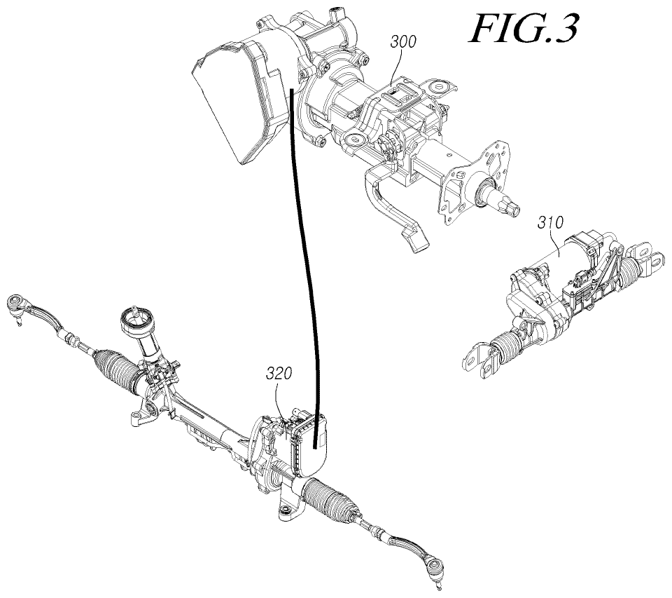

FIG. 3 is another configuration diagram illustrating the steer-by-wire steering apparatus, which is one of the apparatuses to which the present embodiments can be applied.

Referring to FIG. 3, the steer-by-wire steering apparatus may include a steering control system based on a Steering Feedback Actuator (SFA), a Road Wheel Actuator (RWA), and a Rear Wheel Steering (RWS).

The aforementioned steering control system may refer to a system that controls the steering of the vehicle equipped with the steering control system to change according to the rotation angle of the steering wheel operated by a driver.

The steering control system is classified into a mechanical steering control system in which a steering input actuator and a steering output actuator are coupled by a mechanical linkage, and the torque generated if the driver turns the steering wheel is transmitted to the steering motor through a power transmission device including the aforementioned linkage, and a steer-by-wire (SbW) system in which power is transmitted by transmitting and receiving electrical signals through wires, cables, or the like.

If the steering control system is the SbW system, the SFA and RWA may be mechanically separated.

An SFA 300 may refer to an apparatus that inputs the steering information intended by the driver. As described above, the SFA 300 may include a steering wheel, a steering shaft, a reaction motor, and a steering gear.

The steering wheel may be rotated between a left steering lock end and a right steering lock end about the steering shaft as an axis of rotation.

The reaction motor may receive a control signal from the steering control apparatus and provide a feedback torque to the steering wheel. In addition, the reaction motor may receive a control signal from the steering control apparatus and drive at a rotation speed indicated by the control signal to generate the feedback torque, and transmit the feedback torque to the steering wheel through a worm and a worm wheel.

In addition, the SFA 300 may include, in addition to the aforementioned steering wheel, steering shaft, reaction motor, and steering gear, a steering angle sensor for detecting a steering angle of the steering wheel, a torque sensor for detecting driver torque, and a steering angle speed sensor for detecting a steering angle speed of the steering wheel.

A RWA 320 may refer to an apparatus that drives an actual vehicle to steer. This RWA 320 may include a first steering motor, a first rack, a front wheel, a first vehicle speed sensor, a first position sensor, or the like.

Additionally, the SFA 300 and RWA 320 may further include a motor torque sensor capable of detecting the motor torque of the reaction motor and the first steering motor.

The first steering motor may move the first rack axially. Specifically, the first steering motor is driven by receiving a control signal from the steering control apparatus, and may move the first rack linearly in the axial direction. That is, the first rack may move linearly between the left lock end, which is the left movement limit point, and the right lock end, which is the right movement limit point.

The first rack may perform linear motion by driving the first steering motor, and the front wheels may be steered left or right through the linear motion of the first rack.

The steering control system of the present disclosure may further include a clutch or the like capable of separating or combining the SFA and the RWA.

Additionally, the steering control system of the present disclosure may further include an RWS 310 between the SFA and the RWA. The RWS 310 may replace the role of the RWA as needed.

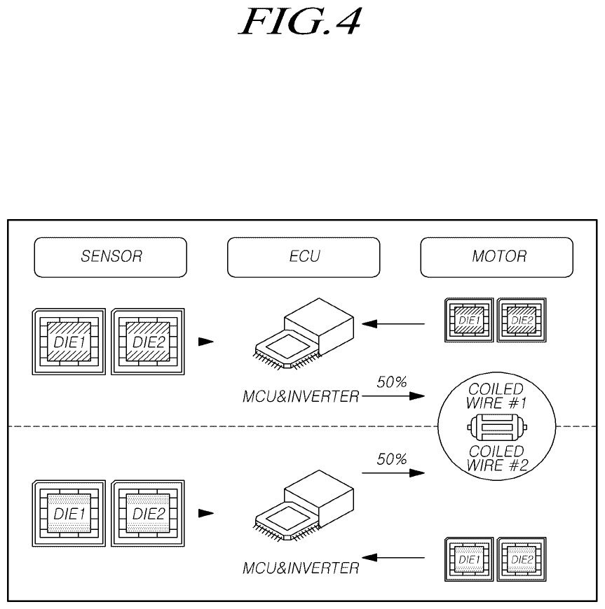

FIG. 4 is a diagram for explaining a Single Point Failure and Dual Point Failure according to one embodiment.

Referring to FIG. 4, the SFA or RWA may be configured as a redundant structure equipped with two sensors, two motors, or two ECUs.

Accordingly, it is possible to prevent the problem of loss of control over vehicle control even if a single failure occurs for each sensor, motor, or ECU. In the present disclosure, the above-described single failure may be referred to as the Single Point Failure.

Additionally, one sensor, motor, or ECU may be set as the main system and the remaining one as the auxiliary system. Therefore, even in a Single Point Failure situation where the main system fails, it can be operated at least 50% of the time.

However, in the case where both are in the failure state, a method for stably controlling the steering of the vehicle is problematic, and as described above, the present disclosure proposes a method for moving the vehicle to a safe location by controlling the switch element included in the ECU.

In the present disclosure, a case where both the main system and the auxiliary system are in the failure states is referred to as a Dual point Failure.

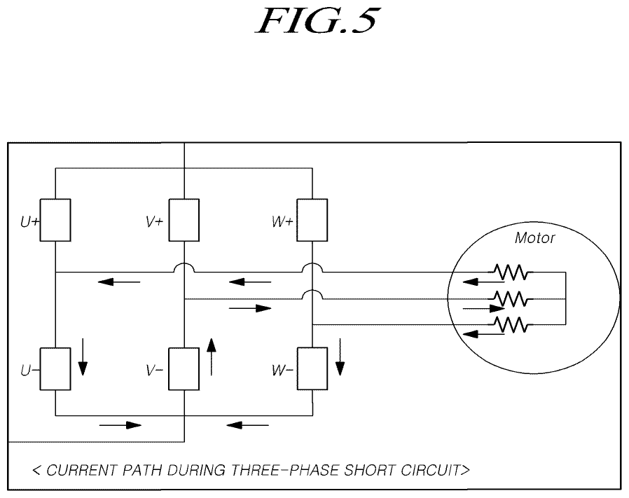

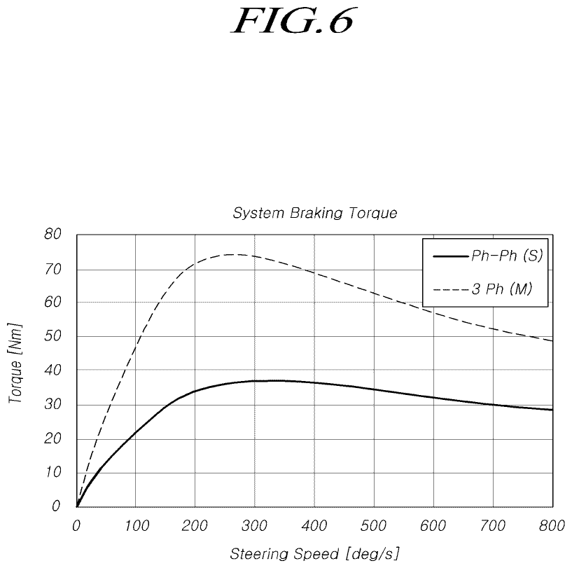

FIGS. 5 and 6 are diagrams for explaining current flow in a three-phase short circuit according to one embodiment.

A power supply method for the motor connected to the SFA or RWA includes a single-phase connection method for supplying power through one phase, and a three-phase connection method for supplying power through three phases.

Referring to FIG. 5, the three-phase connection method is illustrated in which power is supplied to one motor in three phases. A motor connected through the three-phase connection method may have a constant phase difference in the voltage of each phase, and may be supplied with more power than a motor connected through a single-phase connection method.

In the present disclosure, each of the switch elements U+, V+, and W+ illustrated in the upper part of FIG. 5 may be referred to as being located on a High Side, and each of the switch elements U−, V−, and W− illustrated in the lower part may be referred to as being located on a Low Side.

The present disclosure proposes the three-phase connection method, which has higher power efficiency and lower power loss than the single-phase connection method, as the method for supplying power to the motor connected to the SFA or RWA.

Referring to FIG. 6, it can be confirmed that the three-phase connection method (3 Ph) outputs a higher torque compared to the steering speed of an X-axis, compared to the single-phase connection method (Ph-Ph). For example, if the steering speed is 200, the motor according to the single-phase connection method may output about 35 Nm, while the motor according to the three-phase connection method may output about 70 Nm.

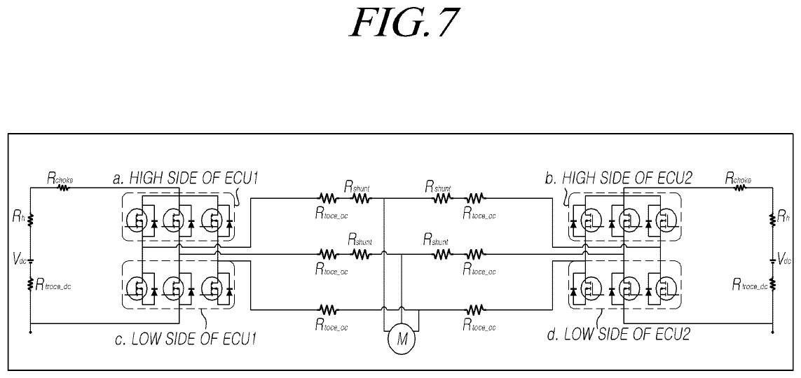

FIG. 7 is a diagram for explaining a method for controlling an ECU in the case of Dual Lane PPk according to one embodiment.

Referring to FIG. 7, the SFA or RWA of the present disclosure may be configured as a Dual Lane PPk structure in which power is supplied to one motor through two three-phase connections.

The steering control apparatus of the present disclosure may control the steering even in the failure state by operating the motor based on the status of the ECU connected to the SFA or RWA if the Dual Point Failure occurs in the aforementioned SFA or RWA. In particular, the free rolling of the rack connected to the RWA may be prevented.

The state of each ECU may be any one of a normal state, a short circuit, or an open circuit.

According to FIG. 7, the motor may be connected to a total of two ECUs, and each ECU may be composed of a high side and a low side.

To explain the SFA as an example, the motors illustrated on the left may be referred to as a first High Side Inverter and a first Low Side Inverter, respectively, and the motors illustrated on the right may be referred to as a second High Side Inverter and a second Low Side Inverter, respectively.

To explain the RWA as an example, the motors illustrated on the left may be referred to as a third High Side Inverter and a third Low Side Inverter, respectively, and the motors illustrated on the right may be referred to as a fourth High Side Inverter and the fourth Low Side Inverter, respectively.

For example, in a case where the SFA is determined to be in the failure state, the steering control apparatus of the present disclosure may control the switch elements of the first High Side Inverter and the second High Side Inverter to be ON if the first High Side Inverter and the second High Side Inverter are in the normal states. Similarly, in a case where the RWA is determined to be in the failure state, the steering control apparatus of the present disclosure may control the switch elements of the third High Side Inverter and the fourth High Side Inverter to be ON if the third High Side Inverter and the fourth High Side Inverter are in the normal states.

As another example, in a case where the SFA is determined to be in the failure state, the steering control apparatus of the present disclosure may control the switch elements of the first Low Side Inverter and the second Low Side Inverter to be ON if the first Low Side Inverter and the second Low Side Inverter are in the normal states. Similarly, in a case where the RWA is determined to be in the failure state, the steering control apparatus of the present disclosure may control the switch elements of the third Low Side Inverter and the fourth Low Side Inverter to be ON if the third Low Side Inverter and the fourth Low Side Inverter are in the normal states.

As still another example, in a case where the SFA is determined to be in the failure state, the steering control apparatus of the present disclosure may control the switch element of the first High Side Inverter to be ON if the first High Side Inverter is in the short circuit, and control the switch element of the first Low Side Inverter to be ON if the first Low Side Inverter is in the short circuit. Similarly, in a case where the RWA is determined to be in the failure state, the steering control apparatus of the present disclosure may control the switch element of the third High Side Inverter to be ON if the third High Side Inverter is in the short circuit, and control the switch element of the third Low Side Inverter to be ON if the third Low Side Inverter is in the short circuit.

As still another example, in a case where the SFA is determined to be in the failure state, the steering control apparatus of the present disclosure may control the switch elements of the first Low Side Inverter and/or the second High Side Inverter to be ON if the first High Side Inverter is in the open circuit and may control the switch elements of the first High Side Inverter and/or the second Low Side Inverter to be ON if the first Low Side Inverter is in the open circuit. Similarly, in a case where the RWA is determined to be in the failure state, the steering control apparatus of the present disclosure may control the switch elements of the third Low Side Inverter and/or the fourth High Side Inverter to be ON if the third High Side Inverter is in the open circuit, and control the switch elements of the third High Side Inverter and/or the fourth Low Side Inverter to be ON if the third Low Side Inverter is in the open circuit.

As still another example, the steering control apparatus of the present disclosure may receive second position information of a second rack from a Rear Wheel Steering (RWS), and control the switch element of the ECU connected to the RWA to provide braking torque to the first rack, and control steering of the vehicle with the second rack based on the second position information if the RWA is determined to be in the failure state.

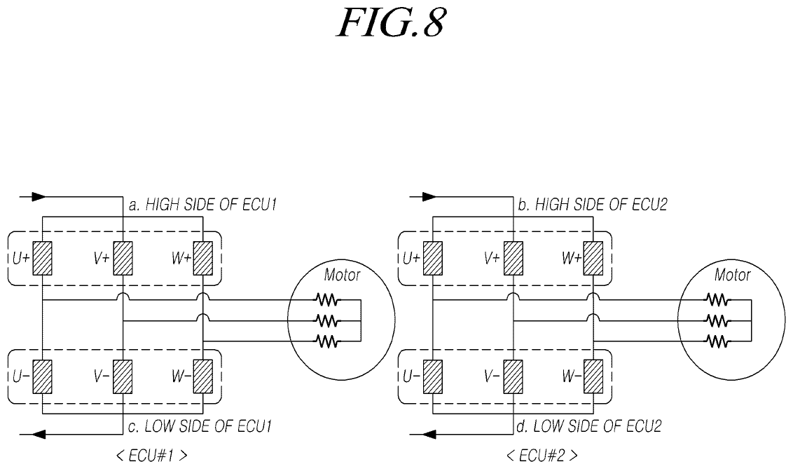

FIG. 8 is a diagram for explaining a method for controlling the ECU in the case of a Dual Powerpack type according to one embodiment.

Referring to FIG. 8, the SFA or RWA of the present disclosure may be set as a Dual Powerpack type structure in which power is supplied to one motor through one three-phase connection.

The steering control apparatus of the present disclosure may control steering even in the failure state by operating each motor based on the status of the ECU connected to the SFA or RWA if the Dual Point Failure occurs in the aforementioned SFA or RWA. In particular, the free rolling of the rack connected to the RWA may be prevented.

The state of each ECU may be any one of the normal state, short circuit, or open circuit, as described above.

As in the case of the Dual Lane PPK structure of FIG. 7, the switch elements of the ECU may be controlled in the same manner in the Dual Powerpack type structure.

For example, the steering control apparatus of the present disclosure may control the switch elements of the first High Side Inverter and the second High Side Inverter to be ON if the SFA is determined to be in the failure state and both the first High Side Inverter and the second High Side Inverter are in the normal states. Similarly, the steering control apparatus of the present disclosure may control the switch elements of the first Low Side Inverter and the second Low Side Inverter to be ON if the SFA is determined to be in the failure state and both the first Low Side Inverter and the second Low Side Inverter are in the normal states.

As another example, the steering control apparatus of the present disclosure may control the switch elements of the third High Side Inverter and the fourth High Side Inverter to be ON if the RWA is determined to be in the failure state and both the third High Side Inverter and the fourth High Side Inverter are in the normal states. Similarly, the steering control apparatus of the present disclosure may control the switch elements of the third Low Side Inverter and the fourth Low Side Inverter to be ON if the RWA is determined to be in the failure state and both the third Low Side Inverter and the fourth Low Side Inverter are in the normal states.

As still another example, if the SFA is determined to be in the failure state and one ECU is in the short circuit, the steering control apparatus of the present disclosure may be set such that the short circuit is configured toward the ECU where the short circuit has occurred. For example, the steering control apparatus of the present disclosure may control the switch element of the first High Side Inverter to be ON if the SFA is determined to be in the failure state and the first High Side Inverter is in the short circuit.

As still another example, if the RWA is determined to be in the failure state and one ECU is in the short circuit, the steering control apparatus of the present disclosure may be set such that the short circuit is configured toward the ECU where the short circuit has occurred. For example, the steering control apparatus of the present disclosure may control the switch element of the third High Side Inverter to be ON if the RWA is determined to be in the failure state and the third High Side Inverter is in the short circuit.

As still another example, if the SFA is determined to be in the failure state and one ECU is in the open circuit, the steering control apparatus of the present disclosure may be set such that the short circuit is configured toward the opposite side of the ECU where the open circuit has occurred. For example, the steering control apparatus of the present disclosure may control the switch elements of the first Low Side Inverter and/or the second High Side Inverter to be ON if the SFA is determined to be in the failure state and the first High Side Inverter is in the open circuit.

As still another example, if the RWA is determined to be in the failure state and one ECU is in the open circuit, the steering control apparatus of the present disclosure may be set such that the short circuit is configured toward the opposite side of the ECU where the open circuit has occurred. For example, the steering control apparatus of the present disclosure may control the switch elements of the third Low Side Inverter and/or the fourth High Side Inverter to be ON if the RWA is determined to be in the failure state and the third High Side Inverter is in the open circuit.

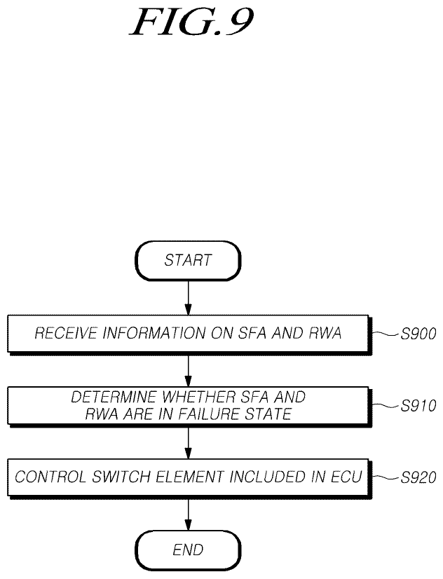

FIG. 9 is a flowchart for explaining a steering control process according to one embodiment.

Referring to FIG. 9, a steering control method of the present disclosure includes a step of receiving at least one of a steering angle of a steering wheel connected to a Steering Feedback Actuator (SFA), a torque, first position information of a first rack connected to a Road Wheel Actuator (RWA), and status information of an ECU connected to each of the SFA and the RWA (S900).

The steering control apparatus of the present disclosure may determine whether the SFA or RWA is in the failure state based on the received information. In addition, the steering control apparatus of the present disclosure may receive the second position information of the second rack from the Rear Wheel Steering (RWS) as needed.

The present disclosure proposes a method for enabling a motor to operate by controlling the switch element of the ECU connected to the SFA or RWA in the failure state if the SFA or RWA is in the failure state. In particular, the present disclosure proposes a method for preventing the first rack of the RWA from becoming free-rolling by controlling the switch element of the ECU mentioned above to provide a braking torque to the motor if the RWA is in the failure state, and controlling the steering of the vehicle through the second rack of the RWS.

The steering control method of the present disclosure includes a step of determining whether the SFA or RWA is in the failure state based on at least one of the steering angle, torque, or first position information (S910).

For example, the steering control apparatus of the present disclosure may determine whether the SFA is in the failure state based on the steering angle and torque, and may determine whether the RWA is in the failure state based on the steering angle, torque, and first position information.

As another example, the status information of the aforementioned ECU may include any one of a normal state, a short circuit, and an open circuit, and at least one of the SFA or RWA may be connected to at least two ECUs.

As still another example, the at least two ECUs connected to the SFA may include the first High Side Inverter, the first Low Side Inverter, the second High Side Inverter and the second Low Side Inverter, and the at least two ECUs connected to the RWA may include the third High Side Inverter, the third Low Side Inverter, the fourth High Side Inverter, and a fourth Low Side Inverter.

The steering control apparatus of the present disclosure may determine whether the SFA or RWA is in the failure state based on the status of each ECU described above, and control the steering of the vehicle by controlling the switch element included in the ECU connected to the apparatus in the failure state based on the determination result.

The steering control method of the present disclosure includes a step of controlling the switch element of the ECU based on the status information of the ECU connected to an SFA or RWA in the failure state if the SFA or RWA is determined to be in the failure state (S920).

In a case where the SFA or RWA is determined to be in the failure state, the steering control apparatus of the present disclosure may control the switch element of each High Side Inverter to be ON if both High Side Inverters connected to the SFA or RWA are in the normal states. Alternatively, the steering control apparatus may control the switch element of each Low Side Inverter to be ON if both Low Side Inverters connected to the SFA or RWA are in the normal states.

In addition, the steering control apparatus of the present disclosure may control the switch elements of the ECU so that the motor is operated according to the status of the inverter of each ECU connected to the SFA or RWA.

For example, in a case where the SFA is determined to be in the failure state, the steering control apparatus of the present disclosure may control the switch element of the first High Side Inverter and the switch element of the second High Side Inverter to be ON if the first High Side Inverter and the second High Side Inverter are in the normal states, and control the switch element of the first Low Side Inverter and the switch element of the second Low Side Inverter to be ON if the first Low Side Inverter and the second Low Side Inverter are in the normal states.

As another example, in a case where the SFA is determined to be in the failure state, the steering control apparatus of the present disclosure may control the switch element of the first High Side Inverter to be ON if the first High Side Inverter is in the short circuit, and control the switch element of the first Low Side Inverter to be ON if the first Low Side Inverter is in the short circuit.

As still another example, in a case where the SFA is determined to be in the failure state, the steering control apparatus of the present disclosure may control the switch elements of the first Low Side Inverter and/or the second High Side Inverter to be ON if the first High Side Inverter is in the open circuit, and control the switch elements of the first High Side Inverter and/or the second Low Side Inverter to be ON if the first Low Side Inverter is in the open circuit.

As still another example, in a case where the RWA is determined to be in the failure state, the steering control apparatus of the present disclosure may control the switch element of the third High Side Inverter and the switch element of the fourth High Side Inverter to be ON if the third High Side Inverter and the fourth High Side Inverter are in the normal states, and control the switch element of the third Low Side Inverter and the switch element of the fourth Low Side Inverter to be ON if the third Low Side Inverter and the fourth Low Side Inverter are in the normal states.

As still another example, in a case where the RWA is determined to be in the failure state, the steering control apparatus of the present disclosure may control the switch element of the third High Side Inverter to be ON if the third High Side Inverter is in the short circuit, and control the switch element of the third Low Side Inverter to be ON if the third Low Side Inverter is in the short circuit.

As still another example, in a case where the RWA is determined to be in the failure state, the steering control apparatus of the present disclosure may control the switch elements of the third Low Side Inverter and/or the fourth High Side Inverter to be ON if the third High Side Inverter is in the open circuit, and control the switch elements of the third High Side Inverter and/or the fourth Low Side Inverter to be ON if the third Low Side Inverter is in the open circuit.

As still another example, the steering control apparatus of the present disclosure may receive second position information of the second rack from the Rear Wheel Steering (RWS), and may control the switch element of the ECU connected to the RWA to provide braking torque to the first rack and control steering of the vehicle with the second rack based on the second position information if the RWA is determined to be in the failure state.

The present disclosure has the advantage of being able to move a vehicle to a safe place by steering with the RWS or Differential Brake if the Dual Point Failure occurs in an SFA or RWA having the Dual Lane PPk structure, being able to prepare for various failure situations of an inverter or switch element in the ECU by applying a safety mechanism, and improving stability in vehicle control without additional parts, elements, or costs.

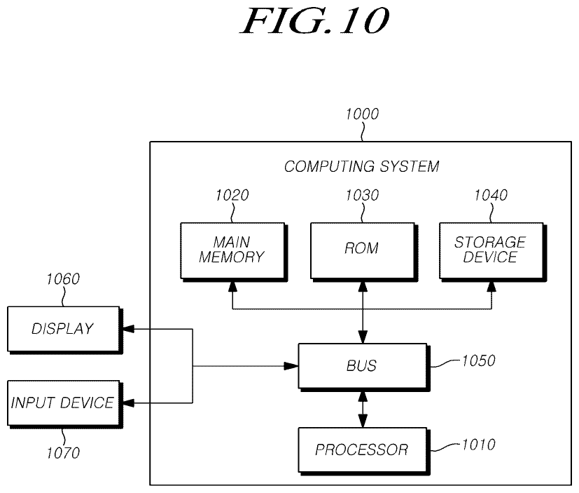

FIG. 10 is a block diagram of an exemplary computing system.

The steering control apparatus according to one embodiment may include at least one memory including computer program instructions and at least one processor 1010 executing the computer program instructions.

For example, the at least one processor 1010 may receive at least one of a steering angle of a steering wheel connected to a Steering Feedback Actuator (SFA), a torque, first position information of a first rack connected to a Road Wheel Actuator (RWA), or status information of an ECU connected to each of the SFA and the RWA, determine whether the SFA or the RWA is in a failure state based on at least one of the steering angle, the torque, or the first position information, and control a switch element of the ECU based on the status information of the ECU connected to the SFA or the RWA in the failure state if the SFA or the RWA is determined to be in the failure state.

Additionally, at least one processor 1010 may determine whether the SFA is in the failure state based on the steering angle and torque, and may determine whether the RWA is in the failure state based on the steering angle, torque, and first position information.

Additionally, the status information of the ECU may include any one of the normal state, the short circuit, and the open circuit, and at least one of the SFA or RWA may be connected to at least two ECUs.

Additionally, the aforementioned SFA may include a first High Side Inverter, a first Low Side Inverter, a second High Side Inverter, and a second Low Side Inverter, and the aforementioned RWA may include a third High Side Inverter, a third Low Side Inverter, a fourth High Side Inverter, and a fourth Low Side Inverter.

In addition, in a case where the SFA is determined to be in the failure state, the at least one processor 1010 may control the switch element of the first High Side Inverter and the switch element of the second High Side Inverter to be ON if the first High Side Inverter and the second High Side Inverter are in the normal states, and control the switch element of the first Low Side Inverter and the switch element of the second Low Side Inverter to be ON if the first Low Side Inverter and the second Low Side Inverter are in the normal states.

Additionally, in a case where the SFA is determined to be in the failure state, the at least one processor 1010 may control the switch element of the first High Side Inverter to be ON if the first High Side Inverter is in the short circuit, and control the switch element of the first Low Side Inverter to be ON if the first Low Side Inverter is in the short circuit.

In addition, in a case where the SFA is determined to be in the failure state, the at least one processor 1010 may control the switch elements of the first Low Side Inverter and/or the second High Side Inverter to be ON if the first High Side Inverter is in the open circuit, and control the switch elements of the first High Side Inverter and/or the second Low Side Inverter to be ON if the first Low Side Inverter is in the open circuit.

In addition, in a case where the RWA is determined to be in the failure state, the at least one processor 1010 may control the switch element of the third High Side Inverter and the switch element of the fourth High Side Inverter to be ON if the third High Side Inverter and the fourth High Side Inverter are in the normal states, and control the switch element of the third Low Side Inverter and the switch element of the fourth Low Side Inverter to be ON if the third Low Side Inverter and the fourth Low Side Inverter are in the normal states.

Additionally, in a case where the RWA is determined to be in the failure state, the at least one processor 1010 may control the switch element of the third High Side Inverter to be ON if the third High Side Inverter is in the short circuit, and control the switch element of the third Low Side Inverter to be ON if the third Low Side Inverter is in the short circuit.

In addition, in a case where the RWA is determined to be in the failure state, the at least one processor 1010 may control the switch elements of the third Low Side Inverter and/or the fourth High Side Inverter to be ON if the third High Side Inverter is in the open circuit, and control the switch elements of the third High Side Inverter and/or the fourth Low Side Inverter to be ON if the third Low Side Inverter is in the open circuit.

Additionally, the at least one processor 1010 may receive second position information of the second rack from the Rear Wheel Steering (RWS), and may control the switch element of the ECU connected to the RWA to provide braking torque to the first rack and control steering of the vehicle with the second rack based on the second position information if the RWA is determined to be in the failure state.

A computing system 1000 or computing device may be used to include or implement components thereof, such as a system or data processing system. The computing system 1000 includes a bus 1050 or other communication component for transmitting information, and the processor 1010 or processing circuitry coupled to the bus for processing information. The computing system 1000 may also include one or more processors 1010 or processing circuitry coupled to the bus 1050 for processing information. The computing system 1000 also includes a main memory, such as a random-access memory (RAM) or other dynamic storage device coupled to the bus 1050, for storing information and commands (instructions) to be executed by the processor. The main memory 1020 may be or include a data store. The main memory 1020 may also be used to store location information, temporary variables, or other intermediate information during execution of commands by the processor 1010. The computing system 1000 may further include a ROM 1030 or other static storage device 1040 coupled to the bus 1050 for storing static information and commands for the processor 1010. A storage device, such as a solid-state device, a magnetic disk, or an optical disk, may be coupled to the bus 1050 for persistently storing information and commands. The storage device 1040 may include or be part of a data store.

The computing system 1000 may be coupled to a display 1060, such as a liquid crystal display or an active-matrix display, to display information to a user via the bus 1050. An input device 1070, such as a keyboard including alphanumeric and other keys, may be coupled to the bus 1050 to convey information and command selections to the processor 1010. The input device 1070 may include a touch screen display. The input device 1070 may also include a cursor control, such as a mouse, trackball, or cursor direction keys, to convey directional information and command selections to the processor 1010 and to control cursor movement on the display. The display 1060 may be part of a data processing system, a client computing device, or other components.

The processes, systems, and methods described herein may be implemented by the computing system 1000 in response to the processor 1010 executing an array of commands contained in the main memory 1020. These commands may be read into the main memory 1020 from another computer-readable medium, such as a storage device. Execution of the array of commands contained in the main memory 1020 causes the computing system 1000 to perform the exemplary processes described herein. In a multiprocessing arrangement, one or more processors 1010 may also be used to execute the commands contained in the main memory 1020. Hard-wired circuitry may be used in place of software commands or in conjunction with hardware commands, in conjunction with the systems and methods described herein. The systems and methods described herein are not limited to any particular combination of hardware circuitry and software.

Although an exemplary computing system 1000 has been described above, the subject matter including the operations described herein may be implemented in other types of digital electronic circuitry, or in computer software, firmware, or hardware including the structures disclosed herein and their structural equivalents, or a combination of one or more of these.

A “data processing system”, “computing device”, “module”, “engine”, “component” or “computing device” includes various apparatuses, devices and machines for processing data, including, for example, a programmable processor, a computer, a system on a chip, or a plurality of such, or combinations thereof. The apparatus may include special purpose logic circuits, for example, a field programmable gate array (FPGA) or an application specific integrated circuit (ASIC). In addition to hardware, the apparatus may also include code that creates an execution environment for the computer program, for example, code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing and grid computing infrastructures. The content request module, the content rendering module or the rendered content delivery module may include or share one or more data processing devices, systems, computing devices or processors. Components of the system may include or share one or more data processing devices, systems, computing devices or processors.

A computer program (also known as a program, software, software application, app, script, or code) may be written in any form of programming language, including compiled or interpreted languages, declarative or procedural languages, and may be distributed as a stand-alone program or in any form including modules, components, subroutines, objects, or other units suitable for use in a computing environment. A computer program may or may not correspond to a file in a file system. A computer program may be stored in part of a file that contains other programs or data (for example, one or more scripts stored in a markup language document), a single file dedicated to the program, or multiple coordinated files (for example, files storing one or more modules, subprograms, or portions of code). A computer program may be distributed to be executed on a single computer or on multiple computers located at a single site or distributed across multiple sites and interconnected by a communication network.

The processes and logic flows described herein can be performed by one or more programmable processors executing one or more computer programs (for example, components of a data processing system) to perform actions by operating on input data and generating output. The processes and logic flows may also be performed by special purpose logic circuitry, such as a field programmable gate array (FPGA) or an application specific integrated circuit (ASIC), and the devices may also be implemented by special purpose logic circuitry. Devices suitable for storing computer program instructions and data include all forms of nonvolatile memory, media and memory devices, including, for example, semiconductor memory devices such as EPROMS, EEPROMs and flash memory devices; magnetic disks, such as internal hard disks or removable disks; magneto-optical disks; and CD ROM and DVD-ROM disks. The processor and memory may be supplemented or integrated with special purpose logic circuitry.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, for example, one or more circuits of computer program instructions, encoded on one or more computer storage media for execution by, or to control the operation of, data processing apparatuses. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (for example, multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments illustrated, but is to be accorded the widest scope consistent with the claims.

What is claimed is:

1. A steering control apparatus comprising:
an information receiver that receives at least one of a steering angle of a steering wheel connected to a Steering Feedback Actuator (SFA), a torque, first position information of a first rack connected to a Road Wheel Actuator (RWA), or status information of an ECU connected to each of the SFA and the RWA;
a failure determinator that determines whether the SFA or the RWA is in a failure state based on at least one of the steering angle, the torque, or the first position information; and
a controller that controls a switch element of the ECU based on the status information of the ECU connected to the SFA or the RWA in the failure state if the SFA or the RWA is determined to be in the failure state.

2. The steering control apparatus of claim 1, wherein the failure determinator
determines whether the SFA is in the failure state based on the steering angle and the torque, and
determines whether the RWA is in the failure state based on the steering angle, the torque, and the first position information.

3. The steering control apparatus of claim 1, wherein the status information of the ECU includes any one of a normal state, a short circuit, or an open circuit, and
at least one of the SFA or the RWA is connected to at least two ECUs.

4. The steering control apparatus of claim 3, wherein the at least two ECUs connected to the SFA include a first High Side Inverter, a first Low Side Inverter, a second High Side Inverter, and a second Low Side Inverter, and
the at least two ECUs connected to the RWA include a third High Side Inverter, a third Low Side Inverter, a fourth High Side Inverter, and a fourth Low Side Inverter.

5. The steering control apparatus of claim 4, wherein in a case where the SFA is determined to be in the failure state,
the controller controls a switch element of the first High Side Inverter and a switch element of the second High Side Inverter to be ON if the first High Side Inverter and the second High Side Inverter are in the normal states, and
controls a switch element of the first Low Side Inverter and a switch element of the second Low Side Inverter to be ON if the first Low Side Inverter and the second Low Side Inverter are in the normal states.

6. The steering control apparatus of claim 4, wherein in a case where the SFA is determined to be in the failure state,
the controller controls a switch element of the first High Side Inverter to be ON if the first High Side Inverter is in the short circuit, and
controls a switch element of the first Low Side Inverter to be ON if the first Low Side Inverter is in the short circuit.

7. The steering control apparatus of claim 4, wherein in a case where the SFA is determined to be in the failure state,
the controller controls switch elements of the first Low Side Inverter and/or the second High Side Inverter to be ON if the first High Side Inverter is in the open circuit, and
controls switch elements of the first High Side Inverter and/or the second Low Side Inverter to be ON if the first Low Side Inverter is in the open circuit.

8. The steering control apparatus of claim 5, wherein in a case where the RWA is determined to be in the failure state,
the controller controls a switch element of the third High Side Inverter and a switch element of the fourth High Side Inverter to be ON if the third High Side Inverter and the fourth High Side Inverter are in the normal states, and
controls a switch element of the third Low Side Inverter and a switch element of the fourth Low Side Inverter to be ON if the third Low Side Inverter and the fourth Low Side Inverter are in the normal states.

9. The steering control apparatus of claim 4, wherein in a case where the RWA is determined to be in the failure state,
the controller controls a switch element of the third High Side Inverter to be ON if the third High Side Inverter is in the short circuit, and
controls a switch element of the third Low Side Inverter to be ON if the third Low Side Inverter is in the short circuit.

10. The steering control apparatus of claim 4, wherein in a case where the RWA is determined to be in the failure state,
the controller controls switch elements of the third Low Side Inverter and/or the fourth High Side Inverter to be ON if the third High Side Inverter is in the open circuit, and
controls switch elements of the third High Side Inverter and/or the fourth Low Side Inverter to be ON if the third Low Side Inverter is in the open circuit.

11. The steering control apparatus of claim 1, wherein the information receiver receives second position information of a second rack from a Rear Wheel Steering (RWS), and
the controller controls a switch element of the ECU connected to the RWA to provide braking torque to the first rack, and controls steering of the vehicle with the second rack based on the second position information if the RWA is determined to be in the failure state.

12. A steering control method comprising:
receiving at least one of a steering angle of a steering wheel connected to a Steering Feedback Actuator (SFA), a torque, first position information of a first rack connected to a Road Wheel Actuator (RWA), or status information of an ECU connected to each of the SFA and the RWA;
determining whether the SFA or the RWA is in a failure state based on at least one of the steering angle, the torque, or the first position information; and
controlling a switch element of the ECU based on the status information of the ECU connected to the SFA or the RWA in the failure state if the SFA or the RWA is determined to be in the failure state.

13. The steering control method of claim 12, wherein the status information of the ECU includes any one of a normal state, a short circuit, or an open circuit, and at least one of the SFA or the RWA is connected to at least two ECUs.

14. The steering control method of claim 13, wherein the at least two ECUs connected to the SFA include a first High Side Inverter, a first Low Side Inverter, a second High Side Inverter, and a second Low Side Inverter, and
the at least two ECUs connected to the RWA include a third High Side Inverter, a third Low Side Inverter, a fourth High Side Inverter, and a fourth Low Side Inverter.

15. The steering control method of claim 13, wherein in a case where the SFA is determined to be in the failure state,
the controller controls a switch element of the first High Side Inverter to be ON if the first High Side Inverter is in the short circuit, and
controls a switch element of the second first Low Side Inverter to be ON if the first Low Side Inverter is in the short circuit.

16. The steering control method of claim 13, wherein in a case where the SFA is determined to be in the failure state,
the controller controls switch elements of the first Low Side Inverter and/or the second High Side Inverter to be ON if the first High Side Inverter is in the open circuit, and
controls switch elements of the first High Side Inverter and/or the second Low Side Inverter to be ON if the first Low Side Inverter is in the open circuit.

17. The steering control method of claim 13, wherein in a case where the RWA is determined to be in the failure state,
the controller controls a switch element of the third High Side Inverter to be ON if the third High Side Inverter is in the short circuit, and
controls a switch element of the third Low Side Inverter to be ON if the third Low Side Inverter is in the short circuit.

18. The steering control method of claim 13, wherein in a case where the SFA is determined to be in the failure state,
the controller controls switch elements of the third Low Side Inverter and/or the fourth High Side Inverter to be ON if the third High Side Inverter is in the open circuit, and
controls switch elements of the third High Side Inverter and/or the fourth Low Side Inverter to be ON if the third Low Side Inverter is in the open circuit.

19. The steering control method of claim 12, wherein the information receiver receives second position information of a second rack from a Rear Wheel Steering (RWS), and
the controller controls a switch element of the ECU connected to the RWA to provide braking torque to the first rack, and controls steering of the vehicle with the second rack based on the second position information if the RWA is determined to be in the failure state.

20. A steering control apparatus comprising:
at least one memory including computer program instructions; and
at least one processor executing the computer program instructions,
wherein the at least one processor
receives at least one of a steering angle of a steering wheel connected to a Steering Feedback Actuator (SFA), a torque, first position information of a first rack connected to a Road Wheel Actuator (RWA), or status information of an ECU connected to each of the SFA and the RWA,
determines whether the SFA or the RWA is in a failure state based on at least one of the steering angle, the torque, or the first position information, and
controls a switch element of the ECU based on the status information of the ECU connected to the SFA or the RWA in the failure state if the SFA or the RWA is determined to be in the failure state.
